(19) United States
(12) Patent Application Publication
(10) Pub. No.: US 2007/0297533 A1
(43) Pub. Date: Dec. 27, 2007

(54) APPARATUS AND METHODS FOR IMPLEMENTING HIERARCHICAL MODULATION AND DEMODULATION FOR GERAN EVOLUTION

(75) Inventors: Prabhakar R. Chitrapu, Blue Bell, PA (US); Paul L. Russell JR., Pennington, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/765,697

(22) Filed: Jun. 20, 2007

Related U.S. Application Data
(60) Provisional application No. 60/816,453, filed on Jun. 26, 2006.

(51) Int. Cl. H04L 27/20

(52) U.S. Cl. 375/308

(57) ABSTRACT

The present invention relates to hierarchical modulation (HM) and demodulation for global system for mobile communications (GSM)/enhanced data rates for GSM evolution (EDGE) radio access network (GERAN) evolution. In one embodiment, HM symbols are generated by generating primary modulated symbols based on a first bit group, generating secondary modulated symbols based on a second bit group, and combining the primary modulated symbols and the secondary modulated symbols. In another embodiment, the HM symbols are demodulated. In yet another embodiment, a received GERAN signal is converted to baseband complex symbol values, which are processed to produce training symbols and data symbols that carry pilot symbols. Channel parameters of the radio channel are estimated based on the training symbols. An equalized signal is generated based on the estimated channel parameters and data symbol. Primary and secondary demodulated symbols are generated based on the equalized signal.

### CROSS REFERENCE TO RELATED APPLICATIONS

This application claims the benefit of U.S. Provisional Application No. 60/816,453 filed Jun. 26, 2006, which is incorporated by reference as if fully set forth.

### FIELD OF INVENTION

The present invention relates generally to the field of wireless communications. More particularly, the present invention relates to hierarchical modulation (HM) and demodulation for global system for mobile communications (GSM)/enhanced data rates for GSM evolution (EDGE) radio access network (GERAN) evolution.

### BACKGROUND

GERAN refers to the globally dominant second generation (2G) digital cellular radio interface, which includes GSM, general packet radio service (GPRS) and EDGE. Since the year 2000, there have been Releases 4-6 of the GERAN standard. Presently, technical work is going on towards the standardization of Release 7, of which GERAN evolution is a part.

There are several motivations for using GERAN evolution. For example, vendors of 2G and third generation (3G) dual mode wireless transmit/receive units (WTRUs) may want to exploit the hardware available for 3G functions for enhanced GERAN functions. Operators would like to provide service continuity between 2G and 3G networks, (e.g., downloads of video clips of sports events).

2 G operators, who do not have 3G licenses, would like to provide enhanced services via GERAN evolution; for example, some operators in the internationally developing markets.

The current GERAN systems use Gaussian minimum shift keying (GMSK) and 8 phase shift keying (PSK) modulations and a number of forward error correction (FEC) schemes, resulting in the 8 modulation and coding schemes (MCSs) shown below in Table 1.

TABLE 1
Current Modulation and Coding Schemes in GERAN

| | | | User Data | |
|---|---|---|---|---|
| Modulation | | Bits | Rate per | |
| and Coding | | per | Timeslot | Coding |
| Scheme | Modulation | symbol | (kbps) | Rate |
| MCS-1 | GMSK | 1 | 8.8 | 0.53 |
| MCS-2 | GMSK | 1 | 11.2 | 0.66 |
| MCS-3 | GMSK | 1 | 14.8 | 0.85 |
| MCS-4 | GMSK | 1 | 17.6 | 1.00 |
| MCS-5 | 8PSK | 3 | 22.4 | 0.37 |
| MCS-6 | 8PSK | 3 | 29.6 | 0.49 |
| MCS-7 | 8PSK | 3 | 44.8 | 0.76 |
| MCS-8 | 8PSK | 3 | 54.4 | 0.92 |
| MCS-9 | 8PSK | 3 | 59.2 | 1.00 |

Note that lower “coding rates” improve the error correction capability and thereby make the data transmission more robust towards channel errors.

Higher order modulation (HOM) schemes are currently being investigated to increase the number of bits per symbol. This intrinsic capability can be utilized to increase the “user data rates” and/or lower the “coding rates”. This in turn results in a number of new MCSs.

In particular, the 16 quadrature amplitude modulation (QAM) and 32 QAM scheme are receiving considerable attention in the GERAN evolution studies. Possible signal constellations are shown in FIG. 1. The bits can be mapped to the symbols using Gray mapping.

For FEC, both convolutional coding as well as the more sophisticated turbo codes are being considered. Turbo codes are especially attractive in conjunction with HOM, because HOM increases the raw bit rate and hence the block size over which FEC is applied, and it is well known that turbo codes perform particularly well with larger block sizes.

Table 2 shows examples of some new MCSs that are made possible with the introduction of 16-QAM/32-QAM and convolutional coding. In these examples, the coding rate is always ⅓, with a constraint length of 7. The coded bits are punctured using uniform puncturing to obtain desired coding rate.

TABLE 2
Examples of New MCSs with 16QAM or 32QAM

| New | | | User Data | |
|---|---|---|---|---|
| Modulation | | Bits | Rate per | |
| and Coding | | per | Timeslot | Coding |
| Schemes | Modulation | symbol | (kbps) | Rate |
| MCS-8-16QAM | 16QAM | 4 | 54.4 | 0.67 |
| MCS-9-16QAM | 16QAM | 4 | 59.2 | 0.73 |
| MCS-10-16QAM | 16QAM | 4 | 67.2 | 0.83 |
| MCS-10-32QAM | 32QAM | 5 | 67.2 | 0.65 |
| MCS-11-32QAM | 32QAM | 5 | 81.6 | 0.79 |

It must be noted that other combinations of user data rates and/or coding rates are possible.

HM refers to a modulation constellation that is partitioned into a number of disjoint sub-constellations. A sub-group of data bits is mapped onto one of the sub-constellations and the remaining bits are mapped into one of the constellation points within the selected sub-constellation. FIG. 2 shows an example.

In FIG. 2, the constellation points within a sub-constellation are at a distance d that is closer together as compared to the distance 4d between the sub-constellations themselves. As such, the probability of error is higher for the secondary bits and smaller for the primary bits. Thus, the less important, (i.e., low priority), bits in the source data stream, (such as a digital video signal), can be mapped as secondary bits, and the more important, (i.e., high priority), bits can be mapped to the primary bits. For example, if the channel conditions are poor, the high priority bit stream may be received, even though the low priority bit stream may be highly corrupted. For such reasons, HM is, in fact, implemented in the digital video broadcasting-terrestrial (DVB-T) standard. Similar concepts are known under different names, such as non-uniform modulation or superposed modulation.

FIG. 3 shows constellations of regular uniformly spaced 16-QAM modulators, viewing 16-QAM as a 4-PSK, where each constellation point is added to another 4-PSK constellation point, scaled by −6 dB, (half the amplitude). An advantage of such an implementation is that each of the modulators is a constant envelope modulator, which is easy to implement since linear power amplifiers are not required.

The uplink state flag (USF) is used on GPRS physical packet data channels (PDCHs) to allow multiplexing of radio blocks from a number of WTRUs. The USF is transmitted on the downlink PDCHs to allocate resources for uplink transfer. The USF is never transmitted in the uplink. The USF is used in two types of medium access, namely dynamic and extended dynamic medium access modes.

The USF comprises 3 bits at the beginning of each radio block that is sent on the downlink. The USF enables the coding of 8 different USF states that are used to multiplex the uplink traffic from multiple users. The USF points either to the next uplink radio block or the sequence of 4 uplink radio bursts starting with the next uplink radio block.

On a packet common control channel (PCCCH), one USF value is used to denote a physical random access channel (PRACH). The other USF values are used to reserve the uplink for different WTRUs. On PDCHs not carrying a PCCCH, the eight USF values are used to reserve the uplink for different WTRUs.

The USF bits are included in the medium access control (MAC) header of a radio link control (RLC)/MAC block. FIGS. 4A and 4B show how RLC/MAC blocks are coded, rate matched, (via puncturing), and mapped onto 4 radio bursts. The dotted lines indicate interleaving to protect against channel fading.

A WTRU has to monitor all downlink radio bursts, detect the USF bits and determine whether the USF belongs to itself, so that it can prepare for its uplink transmission. In general, there will be a mixture of GMSK WTRUs and GMSK+8PSK WTRUs in a given cell. In order for the WTRUs to be able to demodulate all of the downlink radio blocks, it is necessary to segregate downlink GPRS resources (PDCHs) into GMSK-only and 8PSK-only segments, and let all of the WTRUs know about this segregation. It is clear that such segregation reduces the overall combined statistical utilization of the GPRS resources.

Within GERAN Evolution, it is desirable to introduce a new HOM scheme to be compatible with the legacy modulation schemes for the sake of seamless migration, avoid GPRS Resource Segregation and be compatible, (as much as possible), with other GERAN evolution study items.

### SUMMARY

Apparatus and methods of using HM in a GERAN evolved wireless communication system are disclosed. The HM comprises primary and secondary modulation that could, for example, be QPSK modulation.

In one embodiment, HM symbols are generated by generating primary modulated symbols based on a first bit group, generating secondary modulated symbols based on a second bit group, and combining the primary modulated symbols and the secondary modulated symbols.

In another embodiment, the HM symbols are demodulated to produce demodulated primary soft symbol values. The demodulated primary soft symbol values are subtracted from the HM symbols to generate HM symbol values. The HM symbol values are demodulated to produce demodulated secondary soft symbol values. The demodulated primary soft symbol values are converted to demodulated primary hard symbol values. The demodulated secondary soft symbol values are converted to demodulated secondary hard symbol values. The demodulation of the HM symbol values is based on the demodulated primary soft symbol values and the demodulated primary hard symbol values.

In yet another embodiment, a received GERAN signal is converted to baseband complex symbol values, which are processed to produce training symbols and data symbols that carry pilot symbols. Channel parameters of the radio channel are estimated based on the training symbols. An equalized signal is generated based on the estimated channel parameters and data symbol. Primary and secondary demodulated symbols are generated based on the equalized signal.

### BRIEF DESCRIPTION OF THE DRAWINGS

A more detailed understanding of the invention may be had from the following description of a preferred embodiment, given by way of example and to be understood in conjunction with the accompanying drawings:

FIG. 1 shows examples of conventional signal constellations for QAM (16 QAM on the left and 32 QAM on the right);

FIG. 2 shows examples of new MCSs with 16 QAM or 32 QAM;

FIG. 3 shows an example of a conventional QPSK modulator and a superposed 16 QAM modulator;

FIG. 4A shows conventional coding and puncturing for MCS-1; rate 0.53 GMSK, one RLC block per 20 ms;

FIG. 4B shows conventional coding and puncturing for MCS-5; rate 0.37 8PSK, one RLC block per 20 ms;

FIG. 5A shows a first hierarchical realization of 16 QAM (16 HQAM) where both primary and secondary modulations are QPSK in accordance with the present invention;

FIG. 5B shows a second hierarchical realization of 16 QAM (16 HQAM) where the primary modulation is 8 PSK and the secondary modulation is GMSK in accordance with the present invention;

FIG. 5C shows a third hierarchical realization of 16 QAM (16 HQAM) where the primary modulation is GMSK and the secondary modulation is 8 PSK in accordance with the present invention;

FIG. 6 is a block diagram of a hierarchical modulator for implementation of any of the hierarchical realizations of FIGS. 5A-5C in accordance with the present invention;

FIG. 7 is a block diagram of a hierarchical modulator specifically configured for implementation of the second hierarchical realization of FIG. 5B in accordance with the present invention;

FIG. 8 is a block diagram of an HM demodulator to demodulate any of the hierarchical realizations of FIGS. 5A-5C in accordance with the present invention;

FIGS. 9A-9C are block diagrams of various configurations of a receiver that is configured to exploit an embedded pilot in HM when a continuous pilot is provided across a radio burst in accordance with the present invention;

FIG. 10 is a flow diagram of a method of generating HM symbols using the hierarchical modulator of FIG. 6.

FIG. 11 is a flow diagram of a method of processing HM symbols using the HM demodulator of FIG. 8; and

FIG. 12 is a flow diagram of a method of generating primary and secondary demodulated symbols based on an equalized signal using the receiver of FIG. 9A.

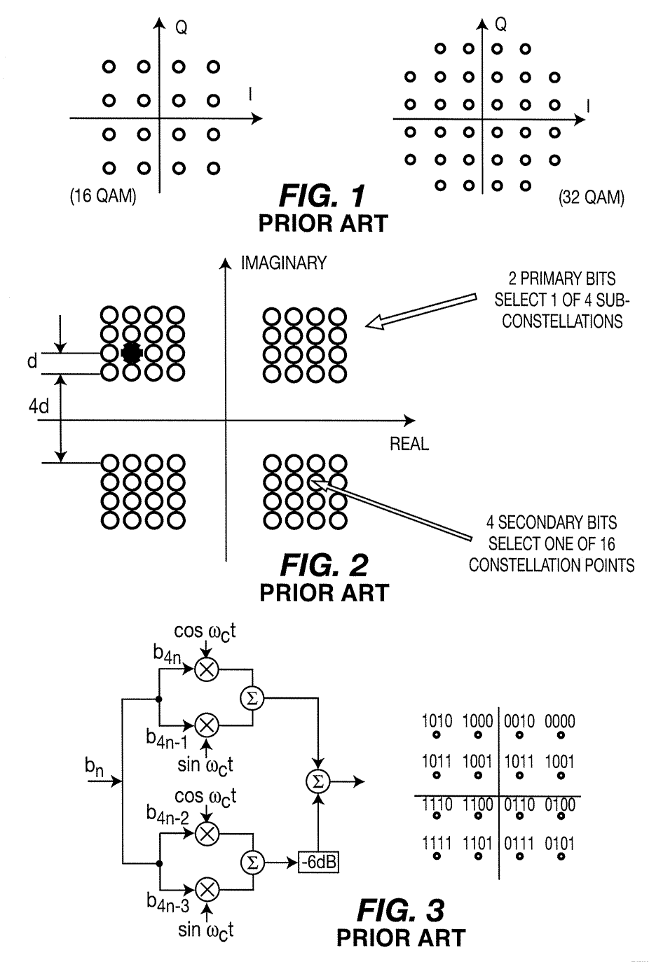

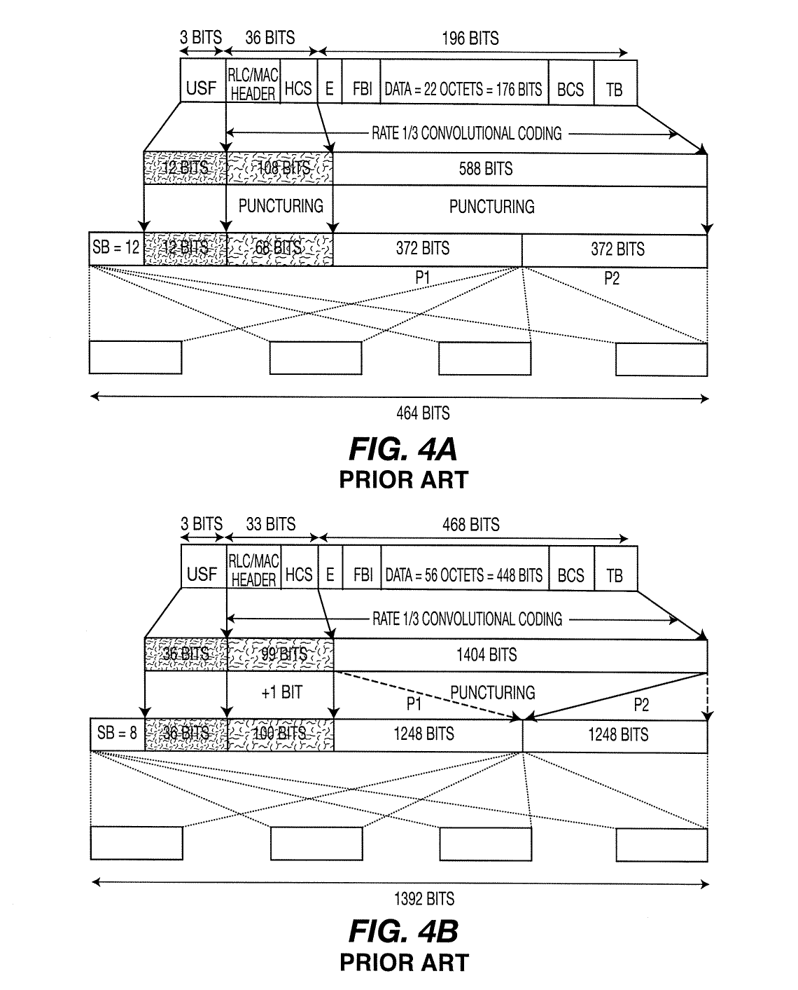

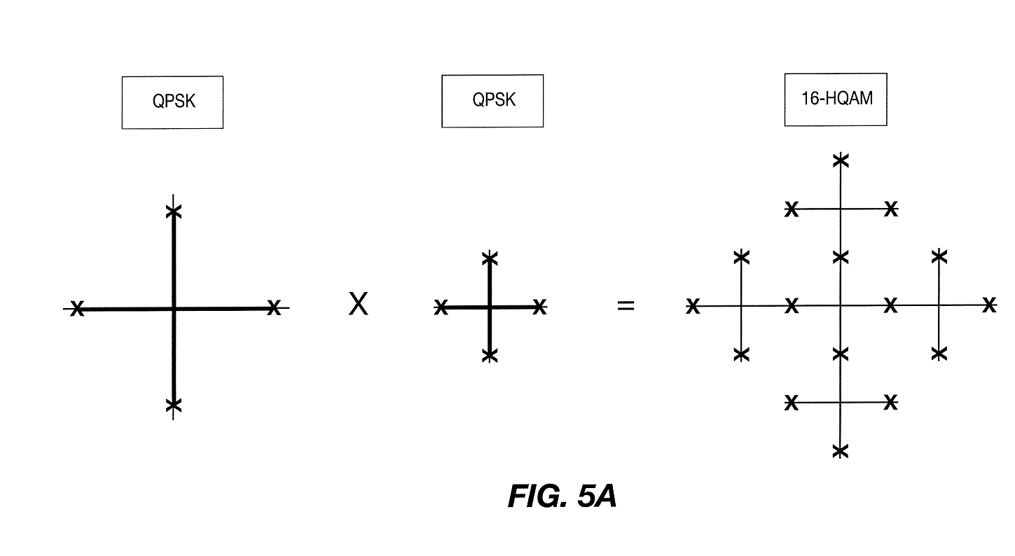

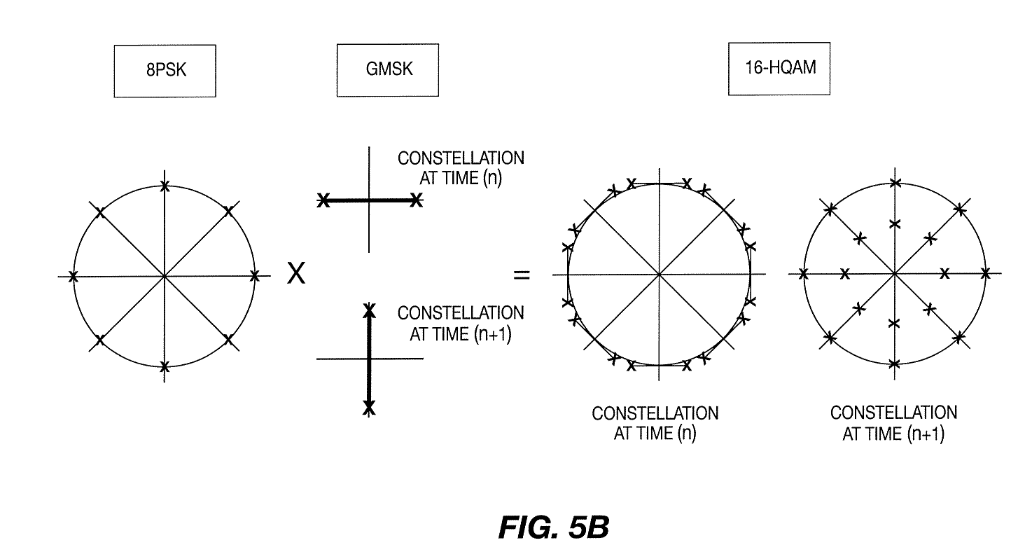

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment. The present invention is relevant to both WTRUs and base stations.

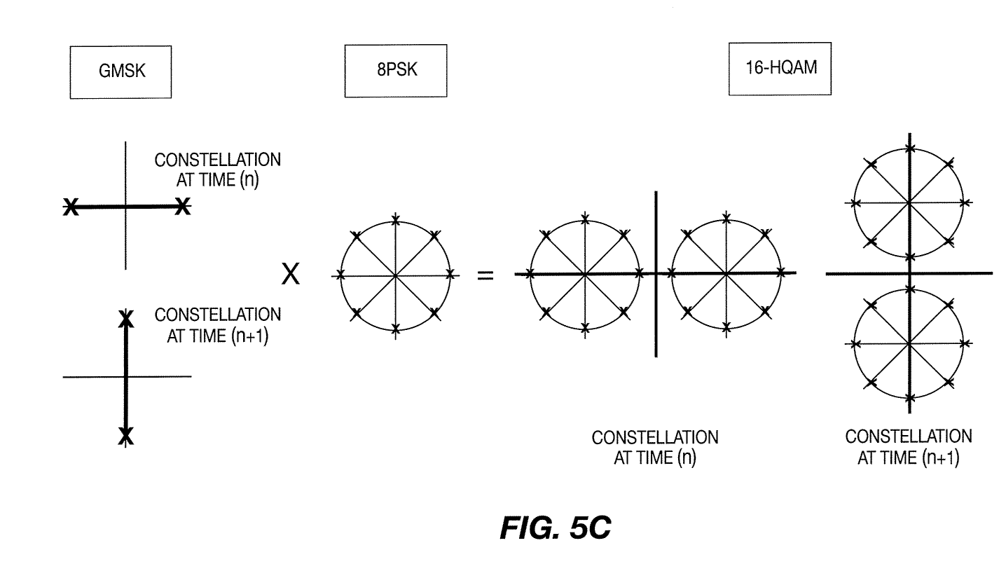

FIG. 5A shows a first hierarchical realization of 16 QAM (16 HQAM) where both primary and secondary modulations are QPSK in accordance with a first embodiment of the present invention. An overall rectangular constellation is formed for the 16HQAM, denoted as 16HQAM-1. The first hierarchical realization may also be referred to as QPSK embedded in 16QAM.

FIG. 5B shows a second hierarchical realization of 16 QAM (16 HQAM) where the primary modulation is 8 PSK and the secondary modulation is GMSK in accordance with a second embodiment of the present invention. The second hierarchical realization is denoted as 16HQAM-2, and may be referred to as 8 PSK embedded in 16 QAM.

FIG. 5C shows a third hierarchical realization of 16 QAM (16HQAM) where the primary modulation is GMSK and the secondary modulation is 8 PSK in accordance with the present invention. The third hierarchical realization is denoted as 16HQAM-3, and may be referred to as GMSK embedded in 16 QAM.

Similarly, other modulation schemes, such as 32 QAM and the like, may also be realized as HM schemes, where the primary modulation is, for example, one of the legacy modulations of GERAN, namely GMSK or 8PSK.

The implementation of these embodiments is preferably extended to the case of non-uniformly spaced HM schemes.

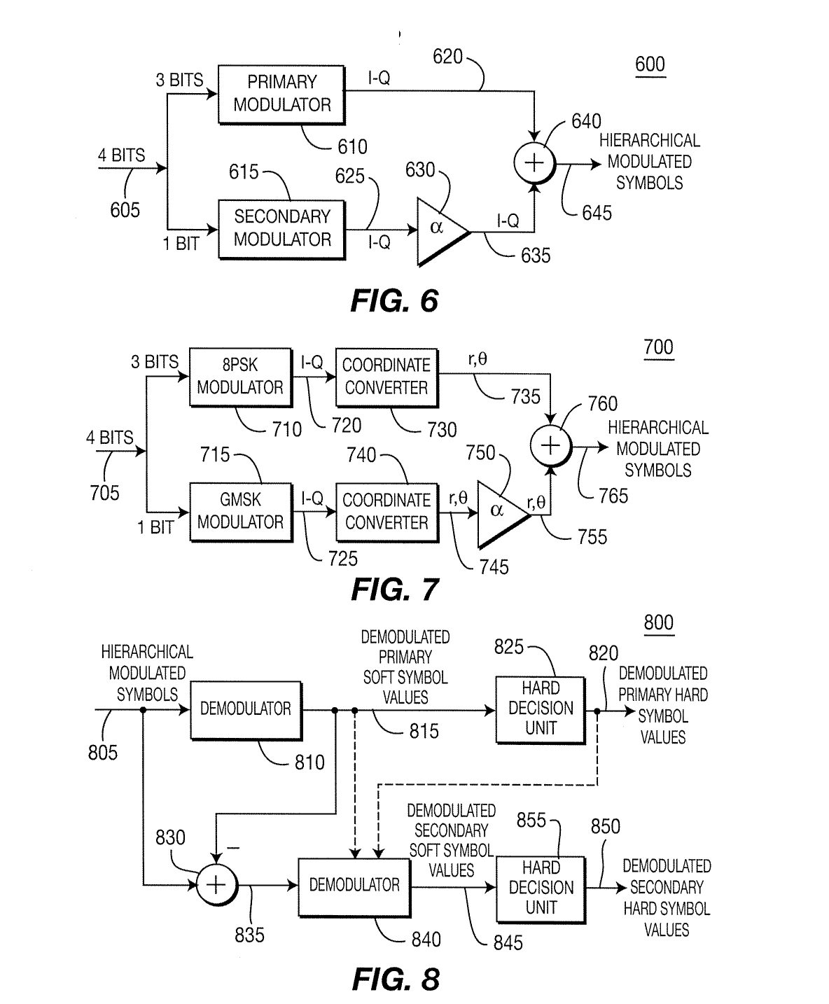

FIG. 6 is a block diagram of a hierarchical modulator 600 configured for implementing any one of the hierarchical realizations of FIGS. 5A-5C in accordance with the present invention. Incoming data 605 is received in blocks of four (4) input bits. Each block is partitioned into a first bit group and a second bit group, (e.g., one group including 3 bits and the other including 1 bit), which are fed into a primary modulator 610 and a secondary modulator 615, respectively. For example, in FIG. 5B, the primary modulator 610 is a GMSK modulator, and the secondary modulator 615 is an 8PSK modulator.

The partitioning is flexible and any suitable method may be used. For example, the first 3 bits are sent to the primary modulator 610 whereas the last bit goes to the secondary modulator 615. The partitioning ratio depends on the constellation size of the primary and secondary modulation schemes. If the primary and secondary sizes are 2ˆP and 2ˆS respectively, then incoming data should be partitioned in the ratio of P/S, where P bits go to the primary modulator 610 and S bits go to the secondary modulator 615. The partitioning of the data bits may be arbitrary or be based on other criteria. In accordance with the present invention, it is desirable that signaling bits, such as USF, go to the primary modulator 615, because the primary modulated symbols are detected by both legacy WTRUs as well as advanced WTRUs. The advanced WTRUs go on further to detect the secondary modulated symbols, whereas the legacy WTRUs stop after the primary modulation detection, (because they are not aware of the advancements, by definition).

The primary modulator 610 outputs primary modulated symbols 620 and the secondary modulator 615 outputs secondary modulated symbols 625. The secondary modulated symbols 625 may be scaled by a scaling amplifier 630, which outputs amplified secondary modulated symbols 635 with a power level that may be adjusted relative to the power level of the primary modulated symbols 620. The scaling amplifier 630 may alternatively be placed in the signal path of the primary modulated symbols 620. The amplified secondary modulated symbols 635 are combined with the primary modulated symbols 620 by an adder 640. The adder 640 outputs HM symbols 645, which are transmitted by either a WTRU or a base station over a radio channel, with optional additional radio frequency (RF) processing steps.

The advantage of this scheme is that a receiver that receives the HM symbols 645 first demodulates the primary modulated symbols 620, and then the amplified secondary modulated symbols 635 in sequence. Certain receivers may skip the secondary demodulation altogether, either because the information meant for the receiver is entirely contained among the primary modulated symbols 620, or the received signal quality makes the demodulation of the amplified secondary modulated symbols 635 unreliable.

All of the HM schemes, namely 16HQAM-1, 16HQAM-2 and 16HQAM-3, may be implemented directly by the modulator 600, where the outputs of the primary modulator 610 and the secondary modulator 615 are complex values in the I-Q domain. The scaling performed by the scaling amplifier 630, as well as the combining (addition) performed by the adder 640 are also implemented in the I-Q domain.

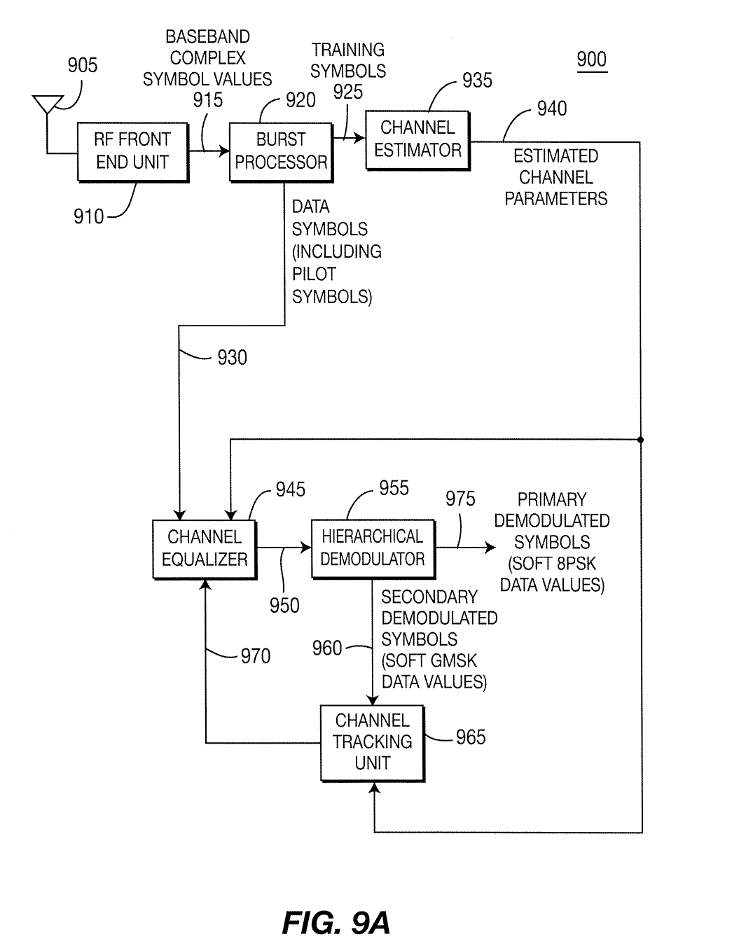

FIG. 7 is a block diagram of a hierarchical modulator 700 specifically configured for implementing the hierarchical realization of FIG. 5B in accordance with the present invention. Incoming data 705 is received in blocks of four (4) input bits. Each block is partitioned into a first bit group and a second bit group, (e.g., one group including 3 bits and the other including 1 bit), which are fed into an 8PSK modulator 710 and a GMSK modulator 715, respectively. The partitioning is flexible and any suitable method may be used, as described above with respect to FIG. 6. The 8PSK modulator 710 outputs 8PSK modulated symbols 720 and the GMSK modulator 715 outputs GMSK modulated symbols 725, which may be represented as complex numbers, (i.e., I-Q pairs). The 8PSK modulated symbols 720 are fed to a first coordinate converter 730, which outputs 8PSK symbol values 735 in polar coordinates (r, θ). The GMSK modulated symbols 725 are fed to a second coordinate converter 740, which outputs GMSK symbol values 745 in polar coordinates (r, θ). The GMSK symbol values 745 may be scaled by a scaling amplifier 750, which outputs amplified GMSK symbol values 755 with a power level that may be adjusted relative to the power of the 8PSK symbol values 735. The scaling amplifier 745 may alternatively be placed in the signal path of the 8PSK symbol values 735. The amplified GMSK symbol values 755 are combined with the 8PSK symbol values 735 by an adder 760. The adder 760 outputs HM symbols 765 that are transmitted by either a WTRU or a base station over a radio channel, with optional additional RF processing steps.

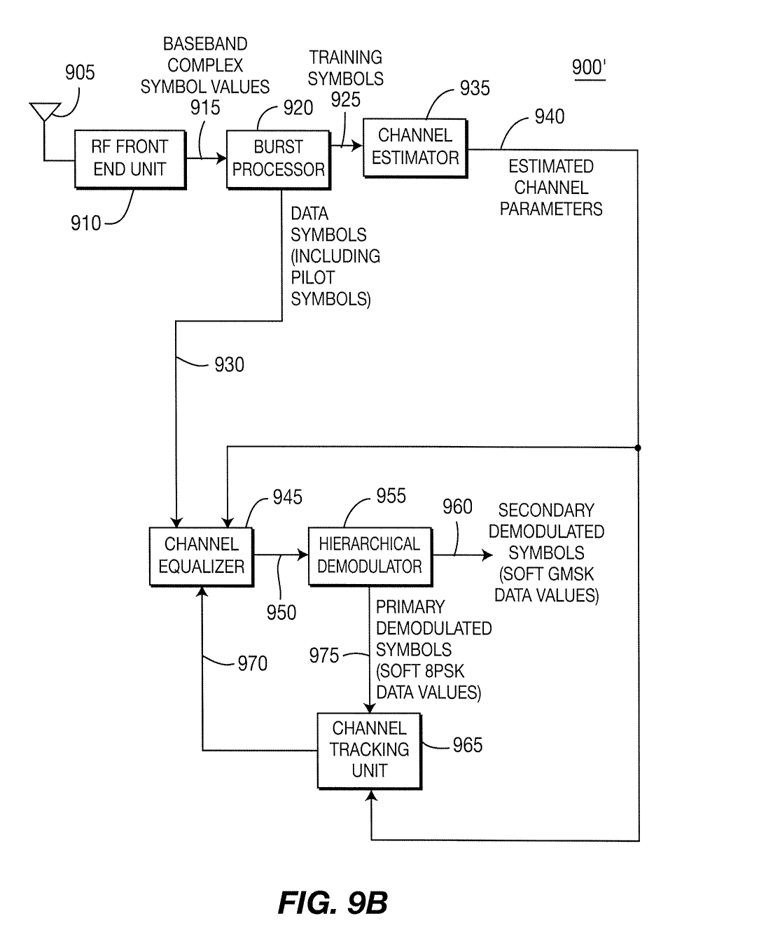

FIG. 8 is a block diagram of a demodulator 800 configured to demodulate any of the hierarchical realizations of FIGS. 5A-5C, (i.e., the HM symbols 645 and 765 generated by the modulators 600 and 700 of FIGS. 6 and 7, respectively), in accordance with the present invention. Input HM symbols 805 are first demodulated for the primary modulated symbols by a first demodulator 810, which produces demodulated primary soft symbol values 815. The demodulated primary soft symbol values 815 are converted to demodulated primary hard symbol values 820, (e.g., binary bits), by a first hard decision unit 825. The demodulated primary soft symbol values 815 are also subtracted from the input HM symbols 805 by an adder 830 which outputs HM symbol values 835. The HM symbol values 835 are demodulated for the secondary modulated symbols by a secondary demodulator 840, which produces demodulated secondary soft symbol values 845. The demodulation performed by the second demodulator 840 may also be based on the demodulated primary soft symbol values 815 and the demodulated primary hard symbol values 820. The demodulated secondary soft symbol values 845 are converted to demodulated secondary hard symbol values 850 by a second hard decision unit 855.

In the following paragraphs, a number of applications of higher order modulations for GERAN, which are realized in a hierarchical manner, are disclosed. They are: 1) transmitting USF in the primary modulation scheme, which is chosen to be one of the legacy modulation schemes, such as GMSK or 8PSK; 2) primary modulation carrying pilot information; 3) mapping data to primary and secondary modulations for unequal protection; and 4) mapping data to primary and secondary modulations for unequal coverage.

The first application is now described. It is well known in prior art that GPRS radio resources are segregated when GMSK and 8PSK mobile stations reside in the same cell, resulting in a decrease in efficiency of radio resource utilization. This is due to the fact that USF bits have to be decoded by all WTRUs on a GPRS PDCH, so that the WTRU may determine whether the USF matches with its own pre-assigned USF value. Suppose that there are two WTRUs, with one being capable of GMSK and 8PSK modulations, and the other being capable of GMSK only, which are both multiplexed on the same PDCH. If the Base Station is sending a downlink GPRS packet, including a USF value, using 8PSK modulation, then the WTRU that is only GSMK capable cannot detect the USF bits. Thus, in practice, when USF being transmitted in the downlink is meant for the GMSK only WTRU, then the base station only sends a GMSK packet, even though the channel conditions can support 8PSK modulation. This results in reduced throughput. Alternately, the two types of WTRUs are assigned to different PDCHs, in which case also there is a trunking inefficiency. When additional modulation schemes, such as 16 QAM and 32QAM, are introduced, further inefficiencies are introduced for the same reasons described above.

HM schemes which use legacy modulation schemes, such as GMSK or 8PSK, for primary modulation avoid this problem of resource segregation. Suppose that data in the downlink is sent using 16QAM modulation, realized an 8PSK primary modulation and GMSK as the secondary modulation. 16 QAM capable WTRUs will decode both the primary as well as secondary modulated symbols, whereas legacy WTRUs that are capable of only GMSK and 8PSK, will only decode the primary modulated symbols. If the USF bits are carried in the primary modulation, then legacy WTRUs as well as advanced WTRUs (that are 16QAM capable) can be multiplexed on the same PDCH, without incurring any inefficiencies.

In the above scheme, USF bits may also be carried redundantly in the secondary modulation as well, thus providing additional robustness against channel impairments.

Primary modulation carrying pilot information: In this application, one of the modulations in the HM scheme is used to carry continuous pilot data across the radio burst. This allows for the WTRU to continually estimate and track the channel, which in turn leads to improved receiver performance. This is especially useful when multiple ‘normal’ radio bursts are ‘aggregated’ into a single longer burst, as the need for channel tracking is greater.

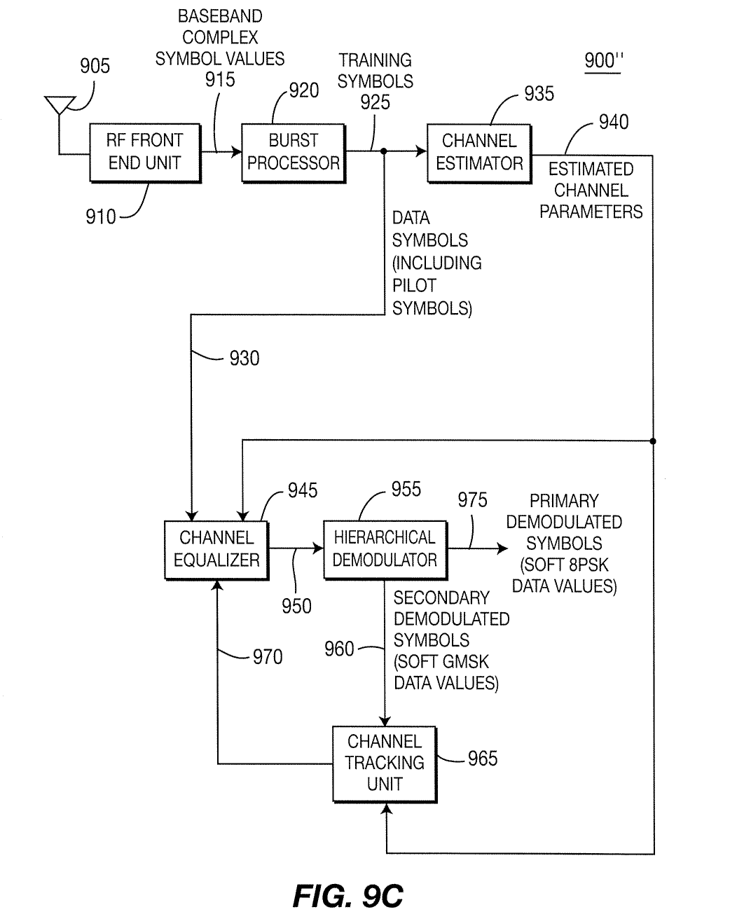

FIGS. 9A-9C are block diagrams of various configurations of a receiver 900 that is configured to exploit an embedded pilot in hierarchical modulation when a continuous pilot is provided across a radio burst in accordance with the present invention. The receiver may be located in a WTRU or a base station.

Referring to FIG. 9A, a GERAN radio signal is received over a radio channel by an antenna 905 of a receiver 900 and is processed by an RF front end unit 910 and is converted to baseband complex symbol values 915. Since GERAN radio signals use radio bursts of symbols, a burst processor 920 is used to process the baseband complex symbol values 915 in a burst to produce training symbols 925 and data symbols 930. The data symbols 930 also carry pilot symbols in either primary or secondary modulated data streams. The training symbols 925 are input into a channel estimator 935 which outputs estimated channel parameters 940 of the radio channel. The estimated channel parameters 940 and the data symbols 930 are input into a channel equalizer 945, which outputs an equalized signal 950, which is demodulated by a hierarchical demodulator 955. The hierarchical demodulator 955 outputs secondary demodulated symbols 960, which are assumed to carry pilot bits that input to a channel tracking unit 965 for tracking the radio channel. The channel tracking unit 965 generates channel tracking results 970 that are fed back to the channel equalizer 945 to improve the equalization performance. The hierarchical demodulator 955 also outputs primary demodulated symbols 975.

As shown in FIG. 9B, the primary and secondary demodulation outputs of the hierarchical demodulator 955 the receiver 900′ of can be switched. This addresses the case when the pilot data is carried by the primary modulation.

As shown in FIG. 9C, auxiliary pilot information in the receiver 900″ is transmitted on top of the data symbols without using the training symbols 925 (of receivers 900 and 900′) altogether. Thus, only the embedded pilot data is used.

From the discussion on HM, it can be seen that data carried by the primary and secondary modulations enjoy different levels of error protection, in general. This property is exploited in this application to transmit the more important data components via the more robust modulation and vice versa.

For example, consider speech coders. The quantized bits are classified into three (3) different groups, depending upon the levels of perceptual importance and they are coded differently. As these coded bits are mapped onto the HM symbols, additional differentiation can be achieved by mapping the perceptually important bits to the more robust modulation. In the specific case of 8PSK/GMSK HM, the important bits are mapped to the primary 8PSK modulation and remaining bits are mapped to the secondary GMSK modulation. Clearly, this added differential protection from the modulation can be used to reduce the differential protection provided by the channel coding schemes.

In another example, consider multimedia broadcast multicast services (MBMS) transmission. Here, different data sub-streams can be mapped onto different modulations. For example, if the MBMS data is associated with stock quotes, the stock value can be mapped to the robust modulation and the name of the company to the secondary modulation.

In yet another example, consider typical transmitted data, which consists of user bits and control bits, (such as headers and the like). On the premise that control bits are more important, they are mapped to the primary modulation.

Alternatively, the data bits in the primary modulation may be considered to have a greater coverage as compared to the data bits in the secondary modulation. This property can be exploited for broadcast information, such as the data carried by a broadcast control channel (BCCH). It is well known that BCCH carries various types of information regarding the system, some of which is useful primarily for user who is already camped onto a specific cell under consideration, and some of which is useful for users who are roaming into this cell, (e.g., cell handover related information). The latter type of information is preferably mapped onto the higher coverage modulation, (i.e., primary modulation).

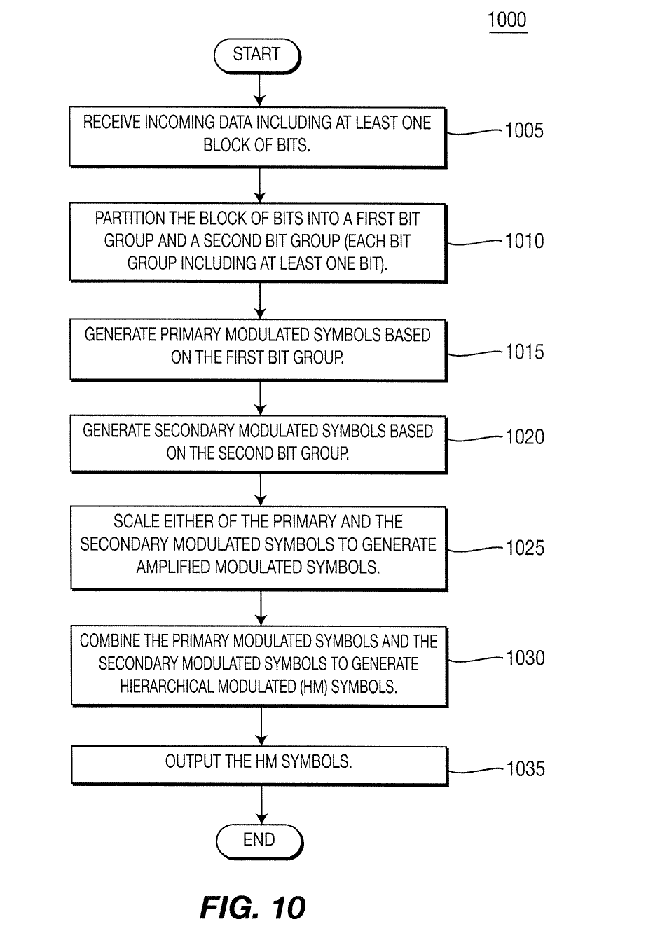

FIG. 10 is a flow diagram of a method 1000 of generating HM symbols using the hierarchical modulator 600 of FIG. 6. Referring to FIGS. 6 and 10, incoming data including at least one block of bits is received at the input 605 of the hierarchical modulator 600 (step 1005). The block of bits is partitioned into a first bit group (e.g., 3 bits) and a second bit group (e.g., 1 bit), each bit group including at least one bit (step 1010). Primary modulated symbols 620 are generated by the primary modulator 610 based on the first bit group (step 1015). Secondary modulated symbols 625 are generated by the secondary modulator 615 based on the second bit group (step 1020). In step 1025, either of the primary and secondary modulated symbols 620, 625 are scaled to generate amplified modulated symbols. For example, as shown in FIG. 6, a scaling amplifier 630 is used to scale the secondary modulated symbols 625 to generate amplified secondary modulated symbols 635, wherein the power level of the secondary modulated symbols 635 is adjusted relative to the power of the primary modulated symbols 620. In step 1030, the primary modulated symbols 620 and the secondary modulated symbols 625 are combined by the adder 640 to generate HM symbols 645. In step 1035, the HM symbols 645 are outputted by the hierarchical modulator 600.

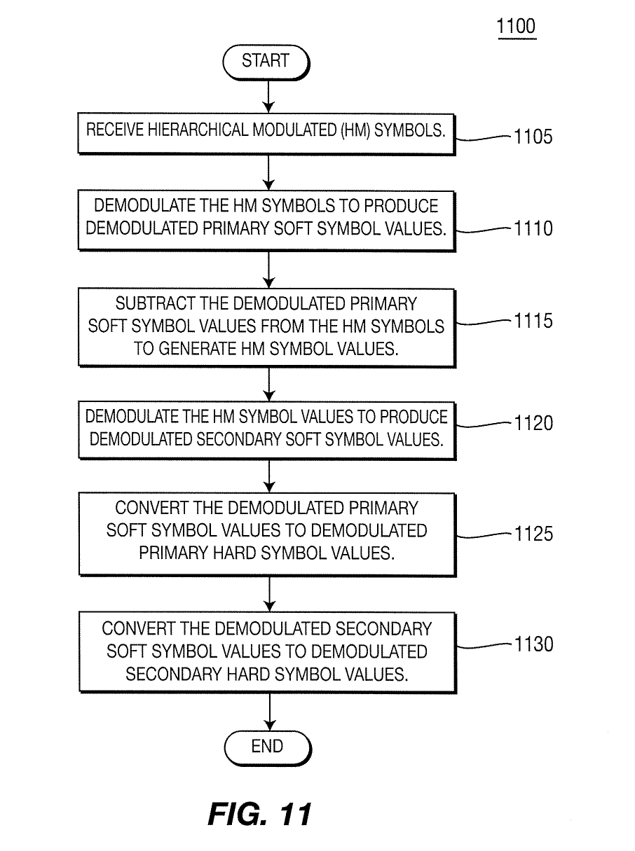

FIG. 11 is a flow diagram of a method 1100 of processing HM symbols using the HM demodulator 800 of FIG. 8. Referring to FIGS. 8 and 11, the input 805 of the HM demodulator 800 receives HM symbols (step 1105). In step 1110, the first demodulator 810 demodulates the HM symbols at the input 805 to produce demodulated primary soft symbol values 815. In step 1115, the adder 830 subtracts the demodulated primary soft symbol values 815 from the HM symbols received at the input 805 to generate HM symbol values 835. In step 1120, the second demodulator 840 demodulates the HM symbol values to produce demodulated secondary soft symbol values 845. In step 1125, the first hard decision unit 825 converts the demodulated primary soft symbol values 815 to demodulated primary hard symbol values 820. In step 1130, the second hard decision unit 855 converts the demodulated secondary soft symbol values 845 to demodulated secondary hard symbol values 850. The demodulation performed by the second demodulator 840 may be based on the demodulated primary soft symbol values 815 and the demodulated primary hard symbol values 820.

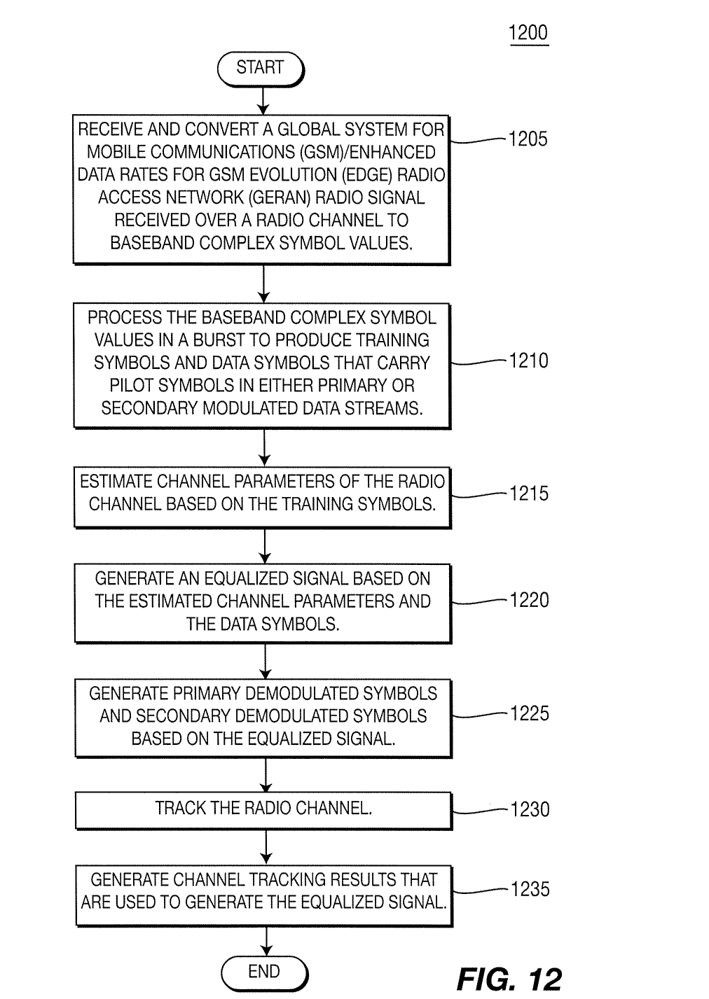

FIG. 12 is a flow diagram of a method 1200 of generating primary and secondary demodulated symbols using the receiver 900 of FIG. 9A based on an equalized signal. Referring to FIGS. 9A and 12, the antenna 905 of the receiver 900 receives a GERAN radio signal over a radio channel, and the RF front end unit 910 converts the GERAN signal to baseband complex symbol values 915 (step 1205). In step 1210, the burst processor 920 processes the baseband complex symbol values 915 in a burst to produce training symbols 925 and data symbols 930 (including pilot symbols) in either primary or secondary modulated data streams. In step 1215, the channel estimator 935 generates estimated channel parameters 940 of the radio channel based on the training symbols 925. In step 1220, the channel equalizer 945 generates an equalized signal 950 based on the estimated channel parameters 940 and the data symbols 930. In step 1225, the hierarchical demodulator 955 generates primary demodulated symbols 975 and secondary demodulated symbols 960 based on the equalized signal 950. In step 1230, the channel tracking unit 965 tracks the radio channel and generates channel tracking results 970 that are fed back to the channel equalizer 945, in which they are used to generate the equalized signal 950.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A hierarchical modulation method comprising:
receiving incoming data including at least one block of bits;
partitioning the block of bits into a first bit group and a second bit group, each bit group including at least one bit;
generating primary modulated symbols based on the first bit group;
generating secondary modulated symbols based on the second bit group;
combining the primary modulated symbols and the secondary modulated symbols to generate hierarchical modulated (HM) symbols; and
outputting the HM symbols.

2. The method of claim 1 wherein the first bit group includes three bits and the second bit group includes one bit.

3. The method of claim 1 further comprising:
scaling the secondary modulated symbols to generate amplified secondary modulated symbols, wherein the power level of the secondary modulated symbols is adjusted relative to the power of the primary modulated symbols.

4. The method of claim 3 wherein the amplified secondary modulated symbols are combined with the primary modulated symbols.

5. The method of claim 1 further comprising:
scaling the primary modulated symbols to generate amplified primary modulated symbols, wherein the power level of the primary modulated symbols is adjusted relative to the power of the secondary modulated symbols.

6. The method of claim 5 wherein the amplified primary modulated symbols are combined with the secondary modulated symbols.

7. The method of claim 1 wherein the incoming data is associated with an uplink state flag (USF) that is used on general packet radio service (GPRS) physical packet data channels (PDCHs) to allow multiplexing of radio blocks from a number of wireless transmit/receive units (WTRUs).

8. The method of claim 1 wherein the method is implemented in a global system for mobile communications (GSM)/enhanced data rates for GSM evolution (EDGE) radio access network (GERAN) evolution evolved wireless communication system.

9. The method of claim 1 wherein the primary modulated symbols and the secondary modulated symbols are quadrature phase shift keyed (QPSK) modulated symbols.

10. The method of claim 1 wherein the primary modulated symbols are 8 phase shift keying (8PSK) modulated symbols.

11. The method of claim 10 further comprising:
converting the 8PSK modulated symbols to 8PSK symbol values in polar coordinates.

12. The method of claim 1 wherein the secondary modulated symbols are Gaussian minimum shift keying (GMSK) modulated symbols.

13. The method of claim 12 further comprising:
converting the GMSK modulated symbols to GMSK symbol values in polar coordinates.

14. A hierarchical modulator comprising:
an input configured to receive incoming data including at least one block of bits, and partitioning the block of bits into a first bit group and a second bit group, each bit group including at least one bit;
a primary modulator electrically coupled to the input, the primary modulator configured to generate primary modulated symbols based on the first bit group;
a secondary modulator electrically coupled to the input, the secondary modulator configured to generate secondary modulated symbols based on the second bit group; and
an adder configured to combine the primary modulated symbols and the secondary modulated symbols to generate hierarchical modulated (HM) symbols and output the HM symbols.

15. The hierarchical modulator of claim 14 wherein the first bit group includes three bits and the second bit group includes one bit.

16. The hierarchical modulator of claim 14 further comprising:
a scaling amplifier configured to scale the secondary modulated symbols to generate amplified secondary modulated symbols, wherein the power level of the secondary modulated symbols is adjusted relative to the power of the primary modulated symbols.

17. The hierarchical modulator of claim 16 wherein the amplified secondary modulated symbols are combined with the primary modulated symbols.

18. The hierarchical modulator of claim 14 further comprising:
a scaling amplifier configured to scale the primary modulated symbols to generate amplified primary modulated symbols, wherein the power level of the primary modulated symbols is adjusted relative to the power of the secondary modulated symbols.

19. The hierarchical modulator of claim 18 wherein the amplified primary modulated symbols are combined with the secondary modulated symbols.

20. The hierarchical modulator of claim 14 wherein the incoming data is associated with an uplink state flag (USF) that is used on general packet radio service (GPRS) physical packet data channels (PDCHs) to allow multiplexing of radio blocks from a number of wireless transmit/receive units (WTRUs).

21. The hierarchical modulator of claim 14 wherein the hierarchical modulator is operated in a global system for mobile communications (GSM)/enhanced data rates for GSM evolution (EDGE) radio access network (GERAN) evolution evolved wireless communication system.

22. The hierarchical modulator of claim 14 wherein the primary modulated symbols and the secondary modulated symbols are quadrature phase shift keyed (QPSK) modulated symbols.

23. The hierarchical modulator of claim 14 wherein the primary modulated symbols are 8 phase shift keying (8PSK) modulated symbols.

24. The hierarchical modulator of claim 23 further comprising:
a coordinate converter configured to convert the 8PSK modulated symbols to 8PSK symbol values in polar coordinates.

25. The hierarchical modulator of claim 14 wherein the secondary modulated symbols are Gaussian minimum shift keying (GMSK) modulated symbols.

26. The hierarchical modulator of claim 25 further comprising:
a coordinate converter configured to convert the GMSK modulated symbols to GMSK symbol values in polar coordinates.

27. A wireless transmit/receive unit (WTRU) comprising the hierarchical modulator of claim 14.

28. A base station comprising the hierarchical modulator of claim 14.

29. A hierarchical demodulator comprising:
an input configured to receive hierarchical modulated (HM) symbols;
a first demodulator electrically coupled to the input, the first demodulator configured to demodulate the HM symbols to produce demodulated primary soft symbol values;
an adder electrically coupled to the input and the first demodulator, the adder configured to subtract the demodulated primary soft symbol values from the HM symbols to generate HM symbol values; and
a second demodulator electrically coupled to the adder, the second demodulator configured to demodulate the HM symbol values to produce demodulated secondary soft symbol values.

30. The hierarchical demodulator of claim 29 further comprising:
a first hard decision unit electrically coupled to the first demodulator, the first had decision unit configured to convert the demodulated primary soft symbol values to demodulated primary hard symbol values; and
a second hard decision unit electrically coupled to the second demodulator, the second hard decision unit configured to convert the demodulated secondary soft symbol values to demodulated secondary hard symbol values.

31. The hierarchical demodulator of claim 30 wherein the demodulation performed by the second demodulator is based on the demodulated primary soft symbol values and the demodulated primary hard symbol values.

32. A hierarchical demodulation method comprising:
receiving hierarchical modulated (HM) symbols;
demodulating the HM symbols to produce demodulated primary soft symbol values;
subtracting the demodulated primary soft symbol values from the HM symbols to generate HM symbol values; and
demodulating the HM symbol values to produce demodulated secondary soft symbol values.

33. The method of claim 32 further comprising:
converting the demodulated primary soft symbol values to demodulated primary hard symbol values; and
converting the demodulated secondary soft symbol values to demodulated secondary hard symbol values.

34. The method of claim 33 wherein the demodulation of the HM symbol values is based on the demodulated primary soft symbol values and the demodulated primary hard symbol values.

35. A receiver comprising:
an antenna configured to receiving a global system for mobile communications (GSM)/enhanced data rates for GSM evolution (EDGE) radio access network (GERAN) radio signal over a radio channel;
a radio frequency (RF) front end unit electrically coupled to the antenna, the RF front end unit configured to convert the GERAN signal to baseband complex symbol values;
a burst processor electrically coupled to the RF front end, the burst processor configured to process the baseband complex symbol values in a burst to produce training symbols and data symbols that carry pilot symbols in either primary or secondary modulated data streams;
a channel estimator electrically coupled to the burst processor, the channel estimator generating estimated channel parameters of the radio channel based on the training symbols;
a channel equalizer electrically coupled to the channel estimator and the burst processor, the channel estimator configured to generate an equalized signal based on the estimated channel parameters and the data symbols; and
a hierarchical demodulator electrically coupled to the channel equalizer, the hierarchical demodulator configured to generate primary demodulated symbols and secondary demodulated symbols based on the equalized signal;

36. The receiver of claim 35 further comprising:
a channel tracking unit electrically coupled to the hierarchical demodulator, the channel estimator and the channel equalizer, the channel tracking unit configured to track the radio channel and generate channel tracking results that are fed back to the channel equalizer.

37. A method of processing a global system for mobile communications (GSM)/enhanced data rates for GSM evolution (EDGE) radio access network (GERAN) radio signal received over a radio channel, the method comprising:
converting the GERAN signal to baseband complex symbol values;
processing the baseband complex symbol values in a burst to produce training symbols and data symbols that carry pilot symbols in either primary or secondary modulated data streams;
estimating channel parameters of the radio channel based on the training symbols;
generating an equalized signal based on the estimated channel parameters and the data symbols; and
generating primary demodulated symbols and secondary demodulated symbols based on the equalized signal.

38. The method of claim 37 further comprising:
tracking the radio channel; and
generating channel tracking results that are used to generate the equalized signal.
